(19) United States
(12) Patent Application Publication
(10) Pub. No.: US 2026/0233174 A1
(43) Pub. Date: Aug. 13, 2026

(54) CONTAINER FOR LIQUID AND METHOD ASSOCIATED THEREWITH

(71) Applicant: Spritz, Inc., Brooklyn, NY (US)

(72) Inventors: Mark Wiggins, Brooklyn, NY (US); John Thorp, Brooklyn, NY (US); JonPaul Turner, Brooklyn, NY (US)

(21) Appl. No.: 19/409,377

(22) Filed: Dec. 4, 2025

Related U.S. Application Data
(63) Continuation of application No. 18/186,585, filed on Mar. 20, 2023, now Pat. No. 12,528,058.
(60) Provisional application No. 63/323,441, filed on Mar. 24, 2022.

(51) Int. Cl. B01F 23/2361; B01F 23/237; B01F 35/71; B01F 101/14; B65D 81/32; B65D 85/73

(52) U.S. Cl. CPC B01F 23/23611; B01F 23/237621; B01F 35/71805; B65D 81/3222; B65D 85/73; B01F 2101/14

(57) ABSTRACT

A method includes obtaining a cartridge having a first fluid within an interior of the cartridge, where the cartridge includes a valve; obtaining a container having a second fluid within an interior of the container; obtaining a pressurizer; installing the cartridge within the pressurizer; installing the pressurizer within a container opening at a top end of the container; and opening the valve in the cartridge, to flow the first fluid within the interior of the cartridge through a first flow path in the valve, and a second flow path in the pressurizer into the second fluid in the container.

### CROSS-REFERENCE TO RELATED APPLICATION

This application is a continuation of U.S. patent application Ser. No. 18/186,585, filed Mar. 20, 2023, which claims priority to U.S. provisional patent application 63/323,441, filed Mar. 24, 2022, the disclosure of which are incorporated by reference herein in their entirety.

### FIELD

The present invention relates to a container, and more particularly, to a container that stores a drinkable liquid.

### BACKGROUND

Containers that store drinkable liquids are well known. The containers may be insulated or uninsulated. Examples of such containers include bottles, canteens, and thermoses.

### SUMMARY

The Claims, rather than the Summary, define covered embodiments of the present invention. The Summary is a high-level overview of various aspects of the invention, and introduces some of the concepts that are further described in the Detailed Description below. The Summary is not intended to identify key or essential features of the claimed subject matter, and also is not intended to be used in isolation to determine the scope of the claimed subject matter. The subject matter should be understood by reference to appropriate portions of the entire Specification, any or all drawings, and each claim.

In some embodiments, the present invention provides a method, comprising: obtaining a cartridge having a first fluid within an interior of the cartridge, wherein the cartridge includes a valve; obtaining a container having a second fluid within an interior of the container; obtaining a pressurizer; installing the cartridge within the pressurizer; installing the pressurizer within a container opening at a top end of the container; and opening the valve in the cartridge, to flow the first fluid within the interior of the cartridge through a first flow path in the valve, and a second flow path in the pressurizer into the second fluid in the container.

In some embodiments, the valve is proximate to the top end of the container.

In some embodiments, the first fluid comprises a first pressurized gas.

In some embodiments, the second fluid comprises a liquid.

In some embodiments, the second fluid comprises a drinkable liquid.

In some embodiments, the opening of the valve in the cartridge comprises: opening the valve in the cartridge, to flow the first fluid within the interior of the cartridge through the first flow path in the valve, and the second flow path in the pressurizer into the second fluid in the container, thereby to pressurize the second fluid in the container.

In some embodiments, the first fluid comprises carbon dioxide.

In some embodiments, the method further comprises removing the pressurizer from the container opening at the top end of the container, thereby to provide access to a mixture of the first fluid and the second fluid.

In some embodiments, the installing the pressurizer further comprises engaging threads of the pressurizer with threads of the container.

In some embodiments, the valve comprises: a valve housing; and a valve stem, wherein the valve stem is movable within the valve housing; and the opening the valve in the cartridge further comprises: moving the valve stem in a first direction to permit flow between the valve stem and the valve housing.

In some embodiments, the valve stem further comprises: a third flow path; and a valve disk blocking the third flow path, wherein the valve disk is configured to rupture when exposed to a predetermined pressure.

In some embodiments, at least a portion of the first flow path extends in a first direction, at least a portion of the second flow path extends in a second direction, and the first direction is different than the second direction.

In some embodiments, the first direction is opposite the second direction.

In some embodiments, the present invention provides a method, comprising: obtaining a cartridge, wherein the cartridge comprises: a cartridge body; and a cartridge neck, wherein the cartridge body comprises a cartridge interior storing a first fluid, wherein the cartridge neck includes a valve; obtaining a container, wherein the container comprises a container interior storing a second fluid; obtaining a pressurizer, wherein the pressurizer comprises a pressurizer body; installing the cartridge within the pressurizer body; installing the pressurizer within a container opening at a top end of the container; and opening the valve in the cartridge, to flow the first fluid within the cartridge interior through a first flow path in the valve, and a second flow path in the pressurizer into the second fluid in the container.

In some embodiments, the cartridge neck comprises a first thread, the valve comprises a second thread, and the first thread and the second thread engage with one another.

In some embodiments, the valve further comprises a valve seat, wherein the valve seat is movable between a first position that closes the first flow path, and a second position that opens through the first flow path.

In some embodiments, the valve further comprises a spring, wherein the spring biases the valve toward the first position.

In some embodiments, the method further comprises removing the pressurizer from the container, thereby to provide access to a mixture of the first fluid and the second fluid.

In some embodiments, installing the cartridge within the pressurizer body further comprises installing a cap on an end of the pressurizer body.

In some embodiments, threads of the cap engage with threads of the pressurizer body.

In some embodiments, installing the pressurizer further comprises engaging threads of the pressurizer with threads of the container.

In some embodiments, the valve further comprises a sealing component, wherein the sealing component impedes flow between the valve and the cartridge.

In some embodiments, the valve is proximate to the top end of the container.

In some embodiments, the first fluid comprises a first pressurized gas.

In some embodiments, the opening the valve in the cartridge comprises opening the valve in the cartridge, to flow the first fluid within the cartridge interior through the first flow path in the valve, and the second flow path in the pressurizer into the second fluid in the container, thereby to pressurize the second fluid in the container.

In some embodiments, the first fluid comprises liquid and/or gaseous carbon dioxide.

In some embodiments, the method further comprises removing the pressurizer from the container opening at the top end of the container, thereby to provide access to a mixture of the first fluid and the second fluid in the container.

In some embodiments, installing the pressurizer further comprises engaging threads of the pressurizer with threads of the container.

In some embodiments, the valve comprises: a valve housing; and a valve stem, wherein the valve stem is movable within the valve housing; and the opening the valve in the cartridge further comprises moving the valve stem in a first direction to permit flow between the valve stem and the valve housing.

In some embodiments, the valve stem further comprises: a third flow path; and a valve disk blocking the third flow path, wherein the valve disk is configured to rupture when exposed to a predetermined pressure.

In some embodiments, at least a portion of the first flow path extends in a first direction, at least a portion of the second flow path extends in a second direction, and the first direction is different than the second direction.

In some embodiments, the first direction is opposite the second direction.

### BRIEF DESCRIPTION OF THE DRAWINGS

This section refers to the drawings that form a part of this disclosure, and which illustrate embodiments of materials and methods described herein.

FIG. 1 is a perspective view of a cartridge, in accordance with some embodiments of the invention.

FIG. 2 is a front view of the cartridge, in accordance with some embodiments of the invention.

FIG. 3 is a cross-sectional view of the cartridge, in accordance with some embodiments of the invention.

FIG. 4 is a perspective view of a valve, in accordance with some embodiments of the invention.

FIG. 5 is a front view of the valve, in accordance with some embodiments of the invention.

FIG. 6 is a cross-sectional view of the valve, in accordance with some embodiments of the invention.

FIG. 7 is another cross-sectional view of the valve, in accordance with some embodiments of the invention.

FIG. 8 is another cross-sectional view of the valve, in accordance with some embodiments of the invention.

FIG. 9 is a cross-sectional view of the valve within the cartridge, in accordance with some embodiments of the invention.

FIG. 10 is a perspective view of a pressurizer, in accordance with some embodiments of the invention.

FIG. 11 is a front view of the pressurizer, in accordance with some embodiments of the invention.

FIG. 12 is a cross-sectional view of the pressurizer, the cartridge, the valve, and the container, in accordance with some embodiments of the invention.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in an embodiment,” “in some embodiments,” and any similar phrase or phrases, as used herein, do not necessarily refer to the same embodiment or embodiments, though the phrase or phrases may refer to the same embodiment or embodiments. Furthermore, the phrase “in another embodiment,” and any similar phrase or phrases, as used herein, do not necessarily refer to a different embodiment, although the phrase or phrases may refer to a different embodiment. All embodiments of the disclosure are intended to be combinable without departing from the scope or spirit of the disclosure.

As used herein, terms such as “comprising,” “including,” “having,” “with,” and any similar phrase or phrases, do not limit the scope of a specific claim to the materials or steps recited by the claim.

In some embodiments, the present invention may provide a cartridge in which a fluid (that is, a liquid and/or a gas) is stored with an interior. In some embodiments, the liquid and/or the gas may be a pressurized liquid and/or gas. In some embodiments, a valve may be installed in the cartridge in which the liquid, the gas, the pressurized liquid, and/or the pressurized gas is stored. In some embodiments, the cartridge may be installed in a pressurizer. In some embodiments, the pressurizer may be installed in a container in which a fluid (for example, a liquid) is stored within or in an interior. In some embodiments, the pressurizer may be installed in the container in which a drinkable liquid (that is, a liquid that is suitable for human consumption) is stored within the interior.

In some embodiments, actuation of the valve may flow the liquid, the gas, the pressurized liquid, and/or the pressurized gas stored in the interior of the cartridge, from the interior of the cartridge, through the valve, through the pressurizer, and into the liquid that is stored in the interior of the container. In some embodiments, flowing the liquid, the gas, the pressurized liquid, and/or the pressurized gas stored in the interior of the cartridge, from the interior of the cartridge and into the liquid that is stored in the interior of the container, may mix the liquid and/or the gas from the cartridge with the liquid in the container. In some embodiments, the pressurized liquid and/or gas flowing from the cartridge may pressurize the liquid that is stored in the interior of the container. In some embodiments, the pressurized liquid and/or gas stored in and flowing from the interior of the cartridge may be liquid and/or gaseous carbon dioxide. In some embodiments, the liquid stored in the interior of the container may be a beverage. In some embodiments, the beverage may be one or more of, or something other than, water, fruit juice, vegetable juice, a soft drink, and/or alcohol. In some embodiments, flowing pressurized liquid and/or gaseous carbon dioxide stored in the interior of the cartridge, from the interior of the cartridge, through the valve, through the pressurizer, and into the liquid stored in the interior of the container, may carbonate the liquid stored in the interior of the container.

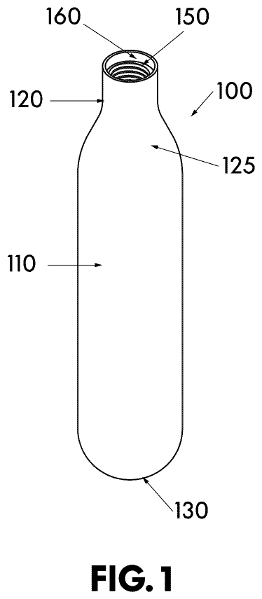

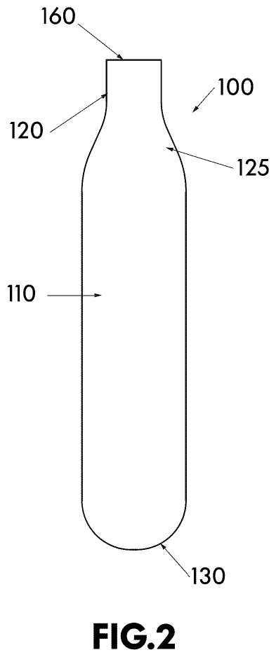

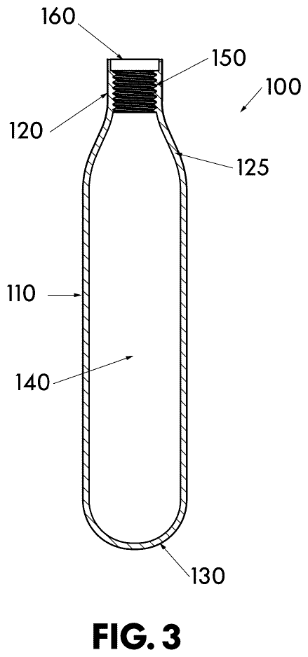

With reference to the drawings, FIG. 1 is a perspective view of a cartridge 100, in accordance with some embodiments of the invention. FIG. 2 is a front view of the cartridge 100, in accordance with some embodiments of the invention. FIG. 3 is a cross-sectional view of the cartridge 100, in accordance with some embodiments of the invention.

As shown in the figures, in some embodiments, the cartridge 100 may include a cartridge body 110. In some embodiments, the cartridge 100 may include a cartridge neck 120. In some embodiments, the cartridge body 110 and the cartridge neck 120 may be connected to one another. In some embodiments, a cartridge intermediate portion 125 may be between the cartridge body 110 and the cartridge neck 120. In some embodiments, the cartridge 100 may include a cartridge base 130. In some embodiments, the cartridge body 110 and the cartridge base 130 may be connected. In some embodiments, the cartridge body 110, the cartridge neck 120, and the cartridge base 130 may define a cartridge interior 140. As discussed, in some embodiments, the cartridge interior 140 may store the liquid, the gas, the pressurized liquid, and/or the pressurized gas therein.

In some embodiments, the cartridge neck 120 may include one or more cartridge threads 150, for attachment with the valve 200 described below. In some embodiments, the cartridge threads 150 may be formed on an interior of the cartridge neck 120. In some embodiments, the cartridge neck 120 may define a cartridge opening 160 into the cartridge interior 140. In some embodiments, the liquid, the gas, the pressurized liquid, and/or the pressurized gas may flow into and/or out of the cartridge interior 140 of the cartridge 100, through the cartridge opening 160 of the cartridge neck 120, as discussed.

As shown in the drawings, in some embodiments, components of the cartridge 100, such as but not limited to the cartridge body 110 and/or the cartridge neck 120, and/or other components, may have a generally cylindrical shape. In some embodiments, the cartridge body 110 may have a circular cross-section. In some embodiments, the cartridge body 110 may have a non-circular cross-section. In some embodiments, the cartridge body 110 may have an elliptical cross-section. In some embodiments, the cartridge body 110 may have an arcuate cross-section.

As shown in the drawings, in some embodiments, the cartridge neck 120 may have a circular cross-section. In some embodiments, the cartridge neck 120 may have a non-circular cross-section. In some embodiments, the cartridge neck 120 may have an elliptical cross-section. In some embodiments, the cartridge neck 120 may have an arcuate cross-section.

In some embodiments, the cartridge intermediate portion 125 may have a circular cross-section. In some embodiments, the cartridge intermediate portion 125 may have a non-circular cross-section. In some embodiments, the cartridge intermediate portion 125 may have an elliptical cross-section. In some embodiments, the cartridge intermediate portion 125 may have an arcuate cross-section. In some embodiments, the cartridge intermediate portion 125 may be a transitional portion of the cartridge 100, connecting the cartridge neck 120 and the cartridge body 110.

In some embodiments, a diameter of the cartridge body 110 may be greater than a diameter of the cartridge neck 120. In some embodiments, the diameter of the cartridge body 110 may be less than the diameter of the cartridge neck 120. In some embodiments, the diameter of the cartridge body 110 may be the same as the diameter of the cartridge neck 120. In some embodiments, one diameter of the cartridge intermediate portion 125 may be the same as the diameter of the cartridge body 110, and a second diameter of the cartridge intermediate portion 125 may be the same as the diameter of the cartridge neck 120. In some embodiments, a third diameter of the cartridge intermediate portion 125 may be less than the first diameter and greater than the second diameter. In some embodiments, the cartridge base 130 may have an arcuate shape. In some embodiments, the cartridge base 130 may have a non-arcuate shape.

In some embodiments, as discussed, the cartridge 100 may store a liquid within the cartridge interior 140. In some embodiments, the cartridge 100 may store a gas within the cartridge interior 140. In some embodiments, the cartridge 100 may store a pressurized liquid within the cartridge interior 140. In some embodiments, the cartridge 100 may store a pressurized gas within the cartridge interior 140. In some embodiments, the cartridge 100 may store one or more of, or all of, a liquid, a gas, a pressurized liquid, and/or a pressurized gas, within the cartridge interior 140.

In some embodiment, the cartridge interior 140 of the cartridge 100 may communicate with a volume outside of the cartridge 100 through the cartridge opening 160 of the cartridge neck 120. In some embodiments, the cartridge interior 140 of the cartridge 100 may be filled with the liquid, the gas, the pressurized liquid, and/or the pressurized gas through the cartridge opening 160—that is, the liquid, the gas, the pressurized liquid, and/or the pressurized gas may flow into the cartridge interior 140 through the cartridge opening 160 of the cartridge neck 120. In some embodiments, the liquid, the gas, the pressurized liquid, and/or the pressurized gas stored in the cartridge interior 140 of the cartridge 100 may flow out of the cartridge 100, through the cartridge opening 160 of the cartridge neck 120.

In some embodiments, the liquid and/or the gas stored within the cartridge interior 140 may be suitable for human consumption. In some embodiments, the liquid and/or the gas may be suitable for adding to another liquid and/or gas stored in container 400, as further described below. In some embodiments, the liquid and/or the gas stored in the cartridge interior 140 of the cartridge 100 may be suitable for pressurizing another liquid stored in the container 400, to which the liquid and/or the gas from the cartridge 100 is added. In some embodiments, the liquid and/or the gas stored in the cartridge interior 140 of the cartridge 100 may be one or more of liquid and/or gaseous air, carbon dioxide, nitrogen, helium, argon, and/or combinations or one or more of these and/or another gas and/or other gases. In some embodiments, the liquid and/or the gas stored in the cartridge interior 140 of the cartridge 100 may be unsuitable for human consumption.

In some embodiments, the cartridge 100 may be manufactured from a metal. In some embodiments, the cartridge 100 may be manufactured from iron. In some embodiments, the cartridge 100 may be manufactured from steel. In some embodiments, the cartridge 100 may be manufactured from stainless steel. In some embodiments, the cartridge 100 may be manufactured from aluminum. In some embodiments, the cartridge 100 may be manufactured from 6061-T6 aluminum. In some embodiments, the cartridge 100 may be anodized. In some embodiments, the cartridge 100 may be anodized 6061-T6 aluminum. In some embodiments, the cartridge 100 may be carbon fiber. In some embodiments, the cartridge 100 may be composites including combinations of the above materials, and/or other materials.

In some embodiments, the cartridge 100 may be manufactured by an extrusion process. In some embodiments, the cartridge 100 may be manufactured from a backwards extrusion process.

In some embodiments, a diameter of the cartridge opening 160 may be less than an outer diameter of the cartridge body 110. In some embodiments, a diameter of the cartridge opening 160 may be less than half of an outer diameter of the cartridge body 110. In some embodiments, a thickness of a wall of the cartridge base 130 of the cartridge 100 may equal to or greater than a thickness of a wall of the cartridge body 110. In some embodiments, the thickness of the wall of the cartridge base 130 may be equal to or greater than a thickness of a wall of the cartridge neck 120. In some embodiments, the thickness of the wall of the cartridge base 130 of the cartridge 100 may be equal to or greater than each of the thickness of the wall of the cartridge body 110 and the thickness of the wall of the cartridge neck 120. In some embodiments, the thickness of the wall of the cartridge base 130 of the cartridge 100 may be less than the thickness of the wall of the cartridge body 110. In some embodiments, the thickness of the wall of the cartridge base 130 may be less than the thickness of the wall of the cartridge neck 120. In some embodiments, the thickness of the wall of the cartridge base 130 of the cartridge 100 may be less than each of the thickness of the wall of the cartridge body 110 and the thickness of the wall of the cartridge neck 120.

In some embodiments, the cartridge threads 150 may be formed as a continuous thread on the interior of the cartridge neck 120 of the cartridge 100. In some embodiments, the cartridge threads 150 may be formed as a continuous thread including 2 threads between the top and bottom ends of the cartridge threads 150, on the interior of the cartridge neck 120 of the cartridge 100. In some embodiments, the cartridge threads 150 may be formed as a continuous thread including at least 2 threads between the top and bottom ends of the cartridge threads 150, on the interior of the cartridge neck 120 of the cartridge 100. In some embodiments, the cartridge threads 150 may be formed as a continuous thread including 3 threads between the top and bottom ends of the cartridge threads 150, on the interior of the cartridge neck 120 of the cartridge 100. In some embodiments, the cartridge threads 150 may be formed as a continuous thread including at least 3 threads between the top and bottom ends of the cartridge threads 150, on the interior of the cartridge neck 120 of the cartridge 100. In some embodiments, the cartridge threads 150 may be formed as a continuous thread including 4 threads between the top and bottom ends of the cartridge threads 150, on the interior of the cartridge neck 120 of the cartridge 100. In some embodiments, the cartridge threads 150 may be formed as a continuous thread including at least 4 threads between the top and bottom ends of the cartridge threads 150, on the interior of the cartridge neck 120 of the cartridge 100. In some embodiments, the cartridge threads 150 may be formed as a continuous thread including 5 threads between the top and bottom ends of the cartridge threads 150, on the interior of the cartridge neck 120 of the cartridge 100. In some embodiments, the cartridge threads 150 may be formed as a continuous thread including at least 5 threads between the top and bottom ends of the cartridge threads 150, on the interior of the cartridge neck 120 of the cartridge 100. In some embodiments, the cartridge threads 150 may be formed as a continuous thread including 6 threads between the top and bottom ends of the cartridge threads 150, on the interior of the cartridge neck 120 of the cartridge 100. In some embodiments, the cartridge threads 150 may be formed as a continuous thread including at least 6 threads between the top and bottom ends of the cartridge threads 150, on the interior of the cartridge neck 120 of the cartridge 100. In some embodiments, the cartridge threads 150 may be formed as a continuous thread including 7 threads between the top and bottom ends of the cartridge threads 150, on the interior of the cartridge neck 120 of the cartridge 100. In some embodiments, the cartridge threads 150 may be formed as a continuous thread including at least 7 threads between the top and bottom ends of the cartridge threads 150, on the interior of the cartridge neck 120 of the cartridge 100. In some embodiments, the cartridge threads 150 may be formed as a continuous thread including 8 threads between the top and bottom ends of the cartridge threads 150, on the interior of the cartridge neck 120 of the cartridge 100. In some embodiments, the cartridge threads 150 may be formed as a continuous thread including at least 8 threads between the top and bottom ends of the cartridge threads 150, on the interior of the cartridge neck 120 of the cartridge 100. In some embodiments, the cartridge threads 150 may be formed as a continuous thread including 9 threads between the top and bottom ends of the cartridge threads 150, on the interior of the cartridge neck 120 of the cartridge 100. In some embodiments, the cartridge threads 150 may be formed as a continuous thread including at least 9 threads between the top and bottom ends of the cartridge threads 150, on the interior of the cartridge neck 120 of the cartridge 100. In some embodiments, the cartridge threads 150 may be formed as a continuous thread including 10 threads between the top and bottom ends of the cartridge threads 150, on the interior of the cartridge neck 120 of the cartridge 100. In some embodiments, the cartridge threads 150 may be formed as a continuous thread including more than 10 threads between the top and bottom ends of the cartridge threads 150, on the interior of the cartridge neck 120 of the cartridge 100.

In some embodiments, a volume of the cartridge interior 140 may be less than 40 ml. In some embodiments, a volume of the cartridge interior 140 may be less than 39 ml. In some embodiments, a volume of the cartridge interior 140 may be less than 38 ml. In some embodiments, a volume of the cartridge interior 140 may be less than 37 ml. In some embodiments, a volume of the cartridge interior 140 may be less than 36 ml. In some embodiments, a volume of the cartridge interior 140 may be less than 35 ml. In some embodiments, a volume of the cartridge interior 140 may be less than 34 ml. In some embodiments, a volume of the cartridge interior 140 may be less than 33 ml. In some embodiments, a volume of the cartridge interior 140 may be less than 32 ml. In some embodiments, a volume of the cartridge interior 140 may be less than 31 ml. In some embodiments, a volume of the cartridge interior 140 may be less than 30 ml. In some embodiments, a volume of the cartridge interior 140 may be less than 29 ml. In some embodiments, a volume of the cartridge interior 140 may be less than 28 ml. In some embodiments, a volume of the cartridge interior 140 may be less than 27 ml. In some embodiments, a volume of the cartridge interior 140 may be less than 26 ml. In some embodiments, a volume of the cartridge interior 140 may be less than 25 ml. In some embodiments, a volume of the cartridge interior 140 may be less than 24 ml. In some embodiments, a volume of the cartridge interior 140 may be less than 23 ml. In some embodiments, a volume of the cartridge interior 140 may be less than 22 ml. In some embodiments, a volume of the cartridge interior 140 may be less than 21 ml. In some embodiments, a volume of the cartridge interior 140 may be less than 20 ml. In some embodiments, a volume of the cartridge interior 140 may be less than 19 ml. In some embodiments, a volume of the cartridge interior 140 may be less than 18 ml. In some embodiments, a volume of the cartridge interior 140 may be less than 17 ml. In some embodiments, a volume of the cartridge interior 140 may be less than 16 ml. In some embodiments, a volume of the cartridge interior 140 may be less than 15 ml. In some embodiments, a volume of the cartridge interior 140 may be less than 14 ml. In some embodiments, a volume of the cartridge interior 140 may be less than 13 ml. In some embodiments, a volume of the cartridge interior 140 may be less than 12 ml. In some embodiments, a volume of the cartridge interior 140 may be less than 11 ml. In some embodiments, a volume of the cartridge interior 140 may be less than 10 ml. In some embodiments, a volume of the cartridge interior 140 may be less than 9 ml. In some embodiments, a volume of the cartridge interior 140 may be less than 8 ml. In some embodiments, a volume of the cartridge interior 140 may be less than 7 ml. In some embodiments, a volume of the cartridge interior 140 may be less than 6 ml. In some embodiments, a volume of the cartridge interior 140 may be less than 5 ml. In some embodiments, a volume of the cartridge interior 140 may be 40 ml. In some embodiments, a volume of the cartridge interior 140 may be 39 ml. In some embodiments, a volume of the cartridge interior 140 may be 38 ml. In some embodiments, a volume of the cartridge interior 140 may be 37 ml. In some embodiments, a volume of the cartridge interior 140 may be 36 ml. In some embodiments, a volume of the cartridge interior 140 may be 35 ml. In some embodiments, a volume of the cartridge interior 140 may be 34 ml. In some embodiments, a volume of the cartridge interior 140 may be 33 ml. In some embodiments, a volume of the cartridge interior 140 may be 32 ml. In some embodiments, a volume of the cartridge interior 140 may be 31 ml. In some embodiments, a volume of the cartridge interior 140 may be 30 ml. In some embodiments, a volume of the cartridge interior 140 may be 29 ml. In some embodiments, a volume of the cartridge interior 140 may be 28 ml. In some embodiments, a volume of the cartridge interior 140 may be 27 ml. In some embodiments, a volume of the cartridge interior 140 may be 26 ml. In some embodiments, a volume of the cartridge interior 140 may be 25 ml. In some embodiments, a volume of the cartridge interior 140 may be 24 ml. In some embodiments, a volume of the cartridge interior 140 may be 23 ml. In some embodiments, a volume of the cartridge interior 140 may be 22 ml. In some embodiments, a volume of the cartridge interior 140 may be 21 ml. In some embodiments, a volume of the cartridge interior 140 may be 20 ml. In some embodiments, a volume of the cartridge interior 140 may be 19 ml. In some embodiments, a volume of the cartridge interior 140 may be 18 ml. In some embodiments, a volume of the cartridge interior 140 may be 17 ml. In some embodiments, a volume of the cartridge interior 140 may be 16 ml. In some embodiments, a volume of the cartridge interior 140 may be 15 ml. In some embodiments, a volume of the cartridge interior 140 may be 14 ml. In some embodiments, a volume of the cartridge interior 140 may be 13 ml. In some embodiments, a volume of the cartridge interior 140 may be 12 ml. In some embodiments, a volume of the cartridge interior 140 may be 11 ml. In some embodiments, a volume of the cartridge interior 140 may be 10 ml. In some embodiments, a volume of the cartridge interior 140 may be 9 ml. In some embodiments, a volume of the cartridge interior 140 may be 8 ml. In some embodiments, a volume of the cartridge interior 140 may be 7 ml. In some embodiments, a volume of the cartridge interior 140 may be 6 ml. In some embodiments, a volume of the cartridge interior 140 may be 5 ml.

In some embodiments, the cartridge 100 may meet or exceed the standard for a DOT (“Department of Transportation”) 3AL seamless aluminum cylinder. In some embodiments, the cartridge 100 may exceed the standard for a DOT 3AL seamless aluminum cylinder. In some embodiments, the cartridge 100 may meet the standard for a DOT 3AL seamless aluminum cylinder. In some embodiments, the cartridge 100 may not meet the standard for a DOT 3AL seamless aluminum cylinder.

In some embodiments, the cartridge 100 may have an overall length of 89.66 mm. In some embodiments, the cartridge 100 may have an overall length greater than 89.66 mm. In some embodiments, the cartridge 100 may have an overall length of less than 89.66 mm.

In some embodiments, the cartridge body 110 of the cartridge 100 may have an outer diameter of greater than 25 mm. In some embodiments, the cartridge body 110 of the cartridge 100 may have an outer diameter of 25 mm. In some embodiments, the cartridge body 110 of the cartridge 100 may have an outer diameter of 24 mm. In some embodiments, the cartridge body 110 of the cartridge 100 may have an outer diameter of 23 mm. In some embodiments, the cartridge body 110 of the cartridge 100 may have an outer diameter of 22 mm. In some embodiments, the cartridge body 110 of the cartridge 100 may have an outer diameter of 21 mm. In some embodiments, the cartridge body 110 of the cartridge 100 may have an outer diameter of 20 mm. In some embodiments, the cartridge body 110 of the cartridge 100 may have an outer diameter of 19 mm. In some embodiments, the cartridge body 110 of the cartridge 100 may have an outer diameter of 18 mm. In some embodiments, the cartridge body 110 of the cartridge 100 may have an outer diameter of 17 mm. In some embodiments, the cartridge body 110 of the cartridge 100 may have an outer diameter of 16 mm. In some embodiments, the cartridge body 110 of the cartridge 100 may have an outer diameter of 15 mm. In some embodiments, the cartridge body 110 of the cartridge 100 may have an outer diameter of 14 mm. In some embodiments, the cartridge body 110 of the cartridge 100 may have an outer diameter of 13 mm. In some embodiments, the cartridge body 110 of the cartridge 100 may have an outer diameter of 12 mm. In some embodiments, the cartridge body 110 of the cartridge 100 may have an outer diameter of 10 mm. In some embodiments, the cartridge body 110 of the cartridge 100 may have an outer diameter of less than 10 mm.

In some embodiments, the cartridge neck 120 of the cartridge 100 may have an inner diameter of greater than 15 mm. In some embodiments, the cartridge neck 120 of the cartridge 100 may have an inner diameter of 15 mm. In some embodiments, the cartridge neck 120 of the cartridge 100 may have an inner diameter of 14 mm. In some embodiments, the cartridge neck 120 of the cartridge 100 may have an inner diameter of 13 mm. In some embodiments, the cartridge neck 120 of the cartridge 100 may have an inner diameter of 12 mm. In some embodiments, the cartridge neck 120 of the cartridge 100 may have an inner diameter of 11 mm. In some embodiments, the cartridge neck 120 of the cartridge 100 may have an inner diameter of 10 mm. In some embodiments, the cartridge neck 120 of the cartridge 100 may have an inner diameter of 9 mm. In some embodiments, the cartridge neck 120 of the cartridge 100 may have an inner diameter of 8 mm. In some embodiments, the cartridge neck 120 of the cartridge 100 may have an inner diameter of 7 mm. In some embodiments, the cartridge neck 120 of the cartridge 100 may have an inner diameter of 6 mm. In some embodiments, the cartridge neck 120 of the cartridge 100 may have an inner diameter of 5 mm. In some embodiments, the cartridge neck 120 of the cartridge 100 may have an inner diameter of less than 5 mm.

In some embodiments, the cartridge 100 may have a wall thickness of greater than 2.0 mm. In some embodiments, the cartridge 100 may have a wall thickness of 2 mm. In some embodiments, the cartridge 100 may have a wall thickness of 1.9 mm. In some embodiments, the cartridge 100 may have a wall thickness of 1.8 mm. In some embodiments, the cartridge 100 may have a wall thickness of 1.7 mm. In some embodiments, the cartridge 100 may have a wall thickness of 1.6 mm. In some embodiments, the cartridge 100 may have a wall thickness of 1.5 mm. In some embodiments, the cartridge 100 may have a wall thickness of 1.4 mm. In some embodiments, the cartridge 100 may have a wall thickness of 1.3 mm. In some embodiments, the cartridge 100 may have a wall thickness of 1.2 mm. In some embodiments, the cartridge 100 may have a wall thickness of 1.1 mm. In some embodiments, the cartridge 100 may have a wall thickness of 1 mm. In some embodiments, the cartridge 100 may have a wall thickness of 0.9 mm. In some embodiments, the cartridge 100 may have a wall thickness of 0.8 mm. In some embodiments, the cartridge 100 may have a wall thickness of 0.7 mm. In some embodiments, the cartridge 100 may have a wall thickness of 0.6 mm. In some embodiments, the cartridge 100 may have a wall thickness of 0.5 mm. In some embodiments, the cartridge 100 may have a wall thickness of less than 0.5 mm.

In some embodiments, the cartridge 100 may have a yield pressure of at least 4,900 PSI. In some embodiments, the cartridge 100 may have a yield pressure of greater than 4,900 PSI. In some embodiments, the cartridge 100 may have a yield pressure of less than 4,900 PSI. In some embodiments, the cartridge 100 may have a burst pressure of at least 6,000 PSI. In some embodiments, the cartridge 100 may have a burst pressure of greater than 6,000 PSI. In some embodiments, the cartridge 100 may have a burst pressure of 6,000 PSI. In some embodiments, the cartridge 100 may have a burst pressure of less than 6,000 PSI.

In some embodiments, a volume of the cartridge interior 140 may be greater than 17 ml. In some embodiments, a volume of the cartridge interior 140 may be 17 ml. In some embodiments, a volume of the cartridge interior 140 may be 16.9 ml. In some embodiments, a volume of the cartridge interior 140 may be 16.8 ml. In some embodiments, a volume of the cartridge interior 140 may be 16.7 ml. In some embodiments, a volume of the cartridge interior 140 may be 16.6 ml. In some embodiments, a volume of the cartridge interior 140 may be 16.5 ml. In some embodiments, a volume of the cartridge interior 140 may be 16.4 ml. In some embodiments, a volume of the cartridge interior 140 may be 16.3 ml. In some embodiments, a volume of the cartridge interior 140 may be 16.2 ml. In some embodiments, a volume of the cartridge interior 140 may be 16.1 ml. In some embodiments, a volume of the cartridge interior 140 may be 16 ml. In some embodiments, a volume of the cartridge interior 140 may be 15.9 ml. In some embodiments, a volume of the cartridge interior 140 may be 15.8 ml. In some embodiments, a volume of the cartridge interior 140 may be 15.7 ml. In some embodiments, a volume of the cartridge interior 140 may be 15.6 ml. In some embodiments, a volume of the cartridge interior 140 may be 15.5 ml. In some embodiments, a volume of the cartridge interior 140 may be 15.4 ml. In some embodiments, a volume of the cartridge interior 140 may be 15.3 ml. In some embodiments, a volume of the cartridge interior 140 may be 15.2 ml. In some embodiments, a volume of the cartridge interior 140 may be 15.1 ml. In some embodiments, a volume of the cartridge interior 140 may be 15 ml. In some embodiments, a volume of the cartridge interior 140 may be 14.9 ml. In some embodiments, a volume of the cartridge interior 140 may be 14.8 ml. In some embodiments, a volume of the cartridge interior 140 may be 14.7 ml. In some embodiments, a volume of the cartridge interior 140 may be 14.6 ml. In some embodiments, a volume of the cartridge interior 140 may be 14.5 ml. In some embodiments, a volume of the cartridge interior 140 may be 14.4 ml. In some embodiments, a volume of the cartridge interior 140 may be 14.3 ml. In some embodiments, a volume of the cartridge interior 140 may be 14.2 ml. In some embodiments, a volume of the cartridge interior 140 may be 14.1 ml. In some embodiments, a volume of the cartridge interior 140 may be 14 ml. In some embodiments, a volume of the cartridge interior 140 may be less than 14 ml.

In some embodiments, the cartridge 100 may be designed to hold more than 20 g of carbon dioxide at a pressure of 850 PSI, when the cartridge 100 is at a temperature of 70 degrees Fahrenheit, within the cartridge interior 140. In some embodiments, the cartridge 100 may be designed to hold 20 g of carbon dioxide at a pressure of 850 PSI, when the cartridge 100 is at a temperature of 70 degrees Fahrenheit, within the cartridge interior 140. In some embodiments, the cartridge 100 may be designed to hold 19 g of carbon dioxide at a pressure of 850 PSI, when the cartridge 100 is at a temperature of 70 degrees Fahrenheit, within the cartridge interior 140. In some embodiments, the cartridge 100 may be designed to hold 18 g of carbon dioxide at a pressure of 850 PSI, when the cartridge 100 is at a temperature of 70 degrees Fahrenheit, within the cartridge interior 140. In some embodiments, the cartridge 100 may be designed to hold 17 g of carbon dioxide at a pressure of 850 PSI, when the cartridge 100 is at a temperature of 70 degrees Fahrenheit, within the cartridge interior 140. In some embodiments, the cartridge 100 may be designed to hold 16 g of carbon dioxide at a pressure of 850 PSI, when the cartridge 100 is at a temperature of 70 degrees Fahrenheit, within the cartridge interior 140. In some embodiments, the cartridge 100 may be designed to hold 15 g of carbon dioxide at a pressure of 850 PSI, when the cartridge 100 is at a temperature of 70 degrees Fahrenheit, within the cartridge interior 140. In some embodiments, the cartridge 100 may be designed to hold 14 g of carbon dioxide at a pressure of 850 PSI, when the cartridge 100 is at a temperature of 70 degrees Fahrenheit, within the cartridge interior 140. In some embodiments, the cartridge 100 may be designed to hold 13 g of carbon dioxide at a pressure of 850 PSI, when the cartridge 100 is at a temperature of 70 degrees Fahrenheit, within the cartridge interior 140. In some embodiments, the cartridge 100 may be designed to hold 12 g of carbon dioxide at a pressure of 850 PSI, when the cartridge 100 is at a temperature of 70 degrees Fahrenheit, within the cartridge interior 140. In some embodiments, the cartridge 100 may be designed to hold 11 g of carbon dioxide at a pressure of 850 PSI, when the cartridge 100 is at a temperature of 70 degrees Fahrenheit, within the cartridge interior 140. In some embodiments, the cartridge 100 may be designed to hold 10 g of carbon dioxide at a pressure of 850 PSI, when the cartridge 100 is at a temperature of 70 degrees Fahrenheit, within the cartridge interior 140. In some embodiments, the cartridge 100 may be designed to hold 9 g of carbon dioxide at a pressure of 850 PSI, when the cartridge 100 is at a temperature of 70 degrees Fahrenheit, within the cartridge interior 140. In some embodiments, the cartridge 100 may be designed to hold 8 g of carbon dioxide at a pressure of 850 PSI, when the cartridge 100 is at a temperature of 70 degrees Fahrenheit, within the cartridge interior 140. In some embodiments, the cartridge 100 may be designed to hold 7 g of carbon dioxide at a pressure of 850 PSI, when the cartridge 100 is at a temperature of 70 degrees Fahrenheit, within the cartridge interior 140. In some embodiments, the cartridge 100 may be designed to hold 6 g of carbon dioxide at a pressure of 850 PSI, when the cartridge 100 is at a temperature of 70 degrees Fahrenheit, within the cartridge interior 140. In some embodiments, the cartridge 100 may be designed to hold 5 g of carbon dioxide at a pressure of 850 PSI, when the cartridge 100 is at a temperature of 70 degrees Fahrenheit, within the cartridge interior 140. In some embodiments, the cartridge 100 may be designed to hold less than 5 g of carbon dioxide at a pressure of 850 PSI, when the cartridge 100 is at a temperature of 70 degrees Fahrenheit, within the cartridge interior 140.

In some embodiments, at least 1% of the gas or liquid in the cartridge 100 may be delivered to the liquid in the container 400. In some embodiments, at least 2% of the gas or liquid in the cartridge 100 may be delivered to the liquid in the container 400. In some embodiments, at least 3% of the gas or liquid in the cartridge 100 may be delivered to the liquid in the container 400. In some embodiments, at least 4% of the gas or liquid in the cartridge 100 may be delivered to the liquid in the container 400. In some embodiments, at least 5% of the gas or liquid in the cartridge 100 may be delivered to the liquid in the container 400. In some embodiments, at least 10% of the gas or liquid in the cartridge 100 may be delivered to the liquid in the container 400. In some embodiments, at least 15% of the gas or liquid in the cartridge 100 may be delivered to the liquid in the container 400. In some embodiments, at least 20% of the gas or liquid in the cartridge 100 may be delivered to the liquid in the container 400. In some embodiments, at least 25% of the gas or liquid in the cartridge 100 may be delivered to the liquid in the container 400. In some embodiments, at least 30% of the gas or liquid in the cartridge 100 may be delivered to the liquid in the container 400. In some embodiments, at least 35% of the gas or liquid in the cartridge 100 may be delivered to the liquid in the container 400. In some embodiments, at least 40% of the gas or liquid in the cartridge 100 may be delivered to the liquid in the container 400. In some embodiments, at least 45% of the gas or liquid in the cartridge 100 may be delivered to the liquid in the container 400. In some embodiments, at least 50% of the gas or liquid in the cartridge 100 may be delivered to the liquid in the container 400. In some embodiments, at least 55% of the gas or liquid in the cartridge 100 may be delivered to the liquid in the container 400. In some embodiments, at least 60% of the gas or liquid in the cartridge 100 may be delivered to the liquid in the container 400. In some embodiments, at least 65% of the gas or liquid in the cartridge 100 may be delivered to the liquid in the container 400. In some embodiments, at least 70% of the gas or liquid in the cartridge 100 may be delivered to the liquid in the container 400. In some embodiments, at least 75% of the gas or liquid in the cartridge 100 may be delivered to the liquid in the container 400. In some embodiments, at least 80% of the gas or liquid in the cartridge 100 may be delivered to the liquid in the container 400. In some embodiments, at least 85% of the gas or liquid in the cartridge 100 may be delivered to the liquid in the container 400. In some embodiments, at least 90% of the gas or liquid in the cartridge 100 may be delivered to the liquid in the container 400. In some embodiments, at least 91% of the gas or liquid in the cartridge 100 may be delivered to the liquid in the container 400. In some embodiments, at least 92% of the gas or liquid in the cartridge 100 may be delivered to the liquid in the container 400. In some embodiments, at least 93% of the gas or liquid in the cartridge 100 may be delivered to the liquid in the container 400. In some embodiments, at least 94% of the gas or liquid in the cartridge 100 may be delivered to the liquid in the container 400. In some embodiments, at least 95% of the gas or liquid in the cartridge 100 may be delivered to the liquid in the container 400. In some embodiments, at least 96% of the gas or liquid in the cartridge 100 may be delivered to the liquid in the container 400. In some embodiments, at least 97% of the gas or liquid in the cartridge 100 may be delivered to the liquid in the container 400. In some embodiments, at least 98% of the gas or liquid in the cartridge 100 may be delivered to the liquid in the container 400. In some embodiments, at least 99% of the gas or liquid in the cartridge 100 may be delivered to the liquid in the container 400. In some embodiments, 100% of the gas or liquid in the cartridge 100 may be delivered to the liquid in the container 400.

In some embodiments, more than 1% of the gas or liquid in the cartridge 100 may be delivered to the liquid in the container 400. In some embodiments, more than 2% of the gas or liquid in the cartridge 100 may be delivered to the liquid in the container 400. In some embodiments, more than 3% of the gas or liquid in the cartridge 100 may be delivered to the liquid in the container 400. In some embodiments, more than 4% of the gas or liquid in the cartridge 100 may be delivered to the liquid in the container 400. In some embodiments, more than 5% of the gas or liquid in the cartridge 100 may be delivered to the liquid in the container 400. In some embodiments, more than 10% of the gas or liquid in the cartridge 100 may be delivered to the liquid in the container 400. In some embodiments, more than 15% of the gas or liquid in the cartridge 100 may be delivered to the liquid in the container 400. In some embodiments, more than 20% of the gas or liquid in the cartridge 100 may be delivered to the liquid in the container 400. In some embodiments, more than 25% of the gas or liquid in the cartridge 100 may be delivered to the liquid in the container 400. In some embodiments, more than 30% of the gas or liquid in the cartridge 100 may be delivered to the liquid in the container 400. In some embodiments, more than 35% of the gas or liquid in the cartridge 100 may be delivered to the liquid in the container 400. In some embodiments, more than 40% of the gas or liquid in the cartridge 100 may be delivered to the liquid in the container 400. In some embodiments, more than 45% of the gas or liquid in the cartridge 100 may be delivered to the liquid in the container 400. In some embodiments, more than 50% of the gas or liquid in the cartridge 100 may be delivered to the liquid in the container 400. In some embodiments, more than 55% of the gas or liquid in the cartridge 100 may be delivered to the liquid in the container 400. In some embodiments, more than 60% of the gas or liquid in the cartridge 100 may be delivered to the liquid in the container 400. In some embodiments, more than 65% of the gas or liquid in the cartridge 100 may be delivered to the liquid in the container 400. In some embodiments, more than 70% of the gas or liquid in the cartridge 100 may be delivered to the liquid in the container 400. In some embodiments, more than 75% of the gas or liquid in the cartridge 100 may be delivered to the liquid in the container 400. In some embodiments, more than 80% of the gas or liquid in the cartridge 100 may be delivered to the liquid in the container 400. In some embodiments, more than 85% of the gas or liquid in the cartridge 100 may be delivered to the liquid in the container 400. In some embodiments, more than 90% of the gas or liquid in the cartridge 100 may be delivered to the liquid in the container 400. In some embodiments, more than 91% of the gas or liquid in the cartridge 100 may be delivered to the liquid in the container 400. In some embodiments, more than 92% of the gas or liquid in the cartridge 100 may be delivered to the liquid in the container 400. In some embodiments, more than 93% of the gas or liquid in the cartridge 100 may be delivered to the liquid in the container 400. In some embodiments, more than 94% of the gas or liquid in the cartridge 100 may be delivered to the liquid in the container 400. In some embodiments, more than 95% of the gas or liquid in the cartridge 100 may be delivered to the liquid in the container 400. In some embodiments, more than 96% of the gas or liquid in the cartridge 100 may be delivered to the liquid in the container 400. In some embodiments, more than 97% of the gas or liquid in the cartridge 100 may be delivered to the liquid in the container 400. In some embodiments, more than 98% of the gas or liquid in the cartridge 100 may be delivered to the liquid in the container 400. In some embodiments, more than 99% of the gas or liquid in the cartridge 100 may be delivered to the liquid in the container 400.

In some embodiments, the cartridge 100 may be designed to hold a liquid and/or gas at a pressure of less than 100 PSI. In some embodiments, the cartridge 100 may be designed to hold a liquid and/or gas at a pressure of less than 150 PSI. In some embodiments, the cartridge 100 may be designed to hold a liquid and/or gas at a pressure of less than 200 PSI. In some embodiments, the cartridge 100 may be designed to hold a liquid and/or gas at a pressure of less than 250 PSI. In some embodiments, the cartridge 100 may be designed to hold a liquid and/or gas at a pressure of less than 300 PSI. In some embodiments, the cartridge 100 may be designed to hold a liquid and/or gas at a pressure of less than 350 PSI. In some embodiments, the cartridge 100 may be designed to hold a liquid and/or gas at a pressure of less than 400 PSI. In some embodiments, the cartridge 100 may be designed to hold a liquid and/or gas at a pressure of less than 450 PSI. In some embodiments, the cartridge 100 may be designed to hold a liquid and/or gas at a pressure of less than 500 PSI. In some embodiments, the cartridge 100 may be designed to hold a liquid and/or gas at a pressure of less than 550 PSI. In some embodiments, the cartridge 100 may be designed to hold a liquid and/or gas at a pressure of less than 600 PSI. In some embodiments, the cartridge 100 may be designed to hold a liquid and/or gas at a pressure of less than 650 PSI. In some embodiments, the cartridge 100 may be designed to hold a liquid and/or gas at a pressure of less than 700 PSI. In some embodiments, the cartridge 100 may be designed to hold a liquid and/or gas at a pressure of less than 750 PSI. In some embodiments, the cartridge 100 may be designed to hold a liquid and/or gas at a pressure of less than 800 PSI. In some embodiments, the cartridge 100 may be designed to hold a liquid and/or gas at a pressure of less than 850 PSI. In some embodiments, the cartridge 100 may be designed to hold a liquid and/or gas at a pressure of less than 900 PSI. In some embodiments, the cartridge 100 may be designed to hold a liquid and/or gas at a pressure of less than 950 PSI. In some embodiments, the cartridge 100 may be designed to hold a liquid and/or gas at a pressure of less than 1000 PSI. In some embodiments, the cartridge 100 may be designed to hold a liquid and/or gas at a pressure of less than 1100 PSI. In some embodiments, the cartridge 100 may be designed to hold a liquid and/or gas at a pressure of less than 1200 PSI. In some embodiments, the cartridge 100 may be designed to hold a liquid and/or gas at a pressure of less than 1300 PSI. In some embodiments, the cartridge 100 may be designed to hold a liquid and/or gas at a pressure of less than 1400 PSI. In some embodiments, the cartridge 100 may be designed to hold a liquid and/or gas at a pressure of less than 1500 PSI.

In some embodiments, the cartridge 100 may be designed to hold a liquid and/or gas at a pressure of greater than 100 PSI. In some embodiments, the cartridge 100 may be designed to hold a liquid and/or gas at a pressure of greater than 150 PSI. In some embodiments, the cartridge 100 may be designed to hold a liquid and/or gas at a pressure of greater than 200 PSI. In some embodiments, the cartridge 100 may be designed to hold a liquid and/or gas at a pressure of greater than 250 PSI. In some embodiments, the cartridge 100 may be designed to hold a liquid and/or gas at a pressure of greater than 300 PSI. In some embodiments, the cartridge 100 may be designed to hold a liquid and/or gas at a pressure of greater than 350 PSI. In some embodiments, the cartridge 100 may be designed to hold a liquid and/or gas at a pressure of greater than 400 PSI. In some embodiments, the cartridge 100 may be designed to hold a liquid and/or gas at a pressure of greater than 450 PSI. In some embodiments, the cartridge 100 may be designed to hold a liquid and/or gas at a pressure of greater than 500 PSI. In some embodiments, the cartridge 100 may be designed to hold a liquid and/or gas at a pressure of greater than 550 PSI. In some embodiments, the cartridge 100 may be designed to hold a liquid and/or gas at a pressure of greater than 600 PSI. In some embodiments, the cartridge 100 may be designed to hold a liquid and/or gas at a pressure of greater than 650 PSI. In some embodiments, the cartridge 100 may be designed to hold a liquid and/or gas at a pressure of greater than 700 PSI. In some embodiments, the cartridge 100 may be designed to hold a liquid and/or gas at a pressure of greater than 750 PSI. In some embodiments, the cartridge 100 may be designed to hold a liquid and/or gas at a pressure of greater than 800 PSI. In some embodiments, the cartridge 100 may be designed to hold a liquid and/or gas at a pressure of greater than 850 PSI. In some embodiments, the cartridge 100 may be designed to hold a liquid and/or gas at a pressure of greater than 900 PSI. In some embodiments, the cartridge 100 may be designed to hold a liquid and/or gas at a pressure of greater than 950 PSI. In some embodiments, the cartridge 100 may be designed to hold a liquid and/or gas at a pressure of greater than 1000 PSI. In some embodiments, the cartridge 100 may be designed to hold a liquid and/or gas at a pressure of greater than 1100 PSI. In some embodiments, the cartridge 100 may be designed to hold a liquid and/or gas at a pressure of greater than 1200 PSI. In some embodiments, the cartridge 100 may be designed to hold a liquid and/or gas at a pressure of greater than 1300 PSI. In some embodiments, the cartridge 100 may be designed to hold a liquid and/or gas at a pressure of greater than 1400 PSI. In some embodiments, the cartridge 100 may be designed to hold a liquid and/or gas at a pressure of greater than 1500 PSI.

In some embodiments, the cartridge 100 may have an overall weight of more than 17 g. In some embodiments, the cartridge 100 may have an overall weight of 17 g. In some embodiments, the cartridge 100 may have an overall weight of 16.9 g. In some embodiments, the cartridge 100 may have an overall weight of 16.8 g. In some embodiments, the cartridge 100 may have an overall weight of 16.7 g. In some embodiments, the cartridge 100 may have an overall weight of 16.6 g. In some embodiments, the cartridge 100 may have an overall weight of 16.5 g. In some embodiments, the cartridge 100 may have an overall weight of 16.4 g. In some embodiments, the cartridge 100 may have an overall weight of 16.3 g. In some embodiments, the cartridge 100 may have an overall weight of 16.2 g. In some embodiments, the cartridge 100 may have an overall weight of 16.1 g. In some embodiments, the cartridge 100 may have an overall weight of 16 g. In some embodiments, the cartridge 100 may have an overall weight of 15.9 g. In some embodiments, the cartridge 100 may have an overall weight of 15.8 g. In some embodiments, the cartridge 100 may have an overall weight of 15.7 g. In some embodiments, the cartridge 100 may have an overall weight of 15.6 g. In some embodiments, the cartridge 100 may have an overall weight of 15.5 g. In some embodiments, the cartridge 100 may have an overall weight of 15.4 g. In some embodiments, the cartridge 100 may have an overall weight of 15.3 g. In some embodiments, the cartridge 100 may have an overall weight of 15.2 g. In some embodiments, the cartridge 100 may have an overall weight of 15.1 g. In some embodiments, the cartridge 100 may have an overall weight of 15 g. In some embodiments, the cartridge 100 may have an overall weight of 14.9 g. In some embodiments, the cartridge 100 may have an overall weight of 14.8 g. In some embodiments, the cartridge 100 may have an overall weight of 14.7 g. In some embodiments, the cartridge 100 may have an overall weight of 14.6 g. In some embodiments, the cartridge 100 may have an overall weight of 14.5 g. In some embodiments, the cartridge 100 may have an overall weight of 14.4 g. In some embodiments, the cartridge 100 may have an overall weight of 14.3 g. In some embodiments, the cartridge 100 may have an overall weight of 14.2 g. In some embodiments, the cartridge 100 may have an overall weight of 14.1 g. In some embodiments, the cartridge 100 may have an overall weight of 14 g. In some embodiments, the cartridge 100 may have an overall weight of less than 14 g.

In some embodiments, the cartridge threads 150 may be M8×1 threads. In some embodiments, the cartridge threads 150 may not be M8×1 threads.

In some embodiments, the cartridge 100, whether or not filled with a liquid and/or a gas, and/or whether pressurized or not, may meet the standards so as to be designated as food grade. In some embodiments, the cartridge 100, whether or not filled with a liquid and/or a gas, and/or whether pressurized or not, may meet the standards so as to be designated as beverage grade. In some embodiments, the cartridge 100, whether or not filled with a liquid and/or a gas, and/or whether pressurized or not, may not meet the standards so as to be designated as food grade. In some embodiments, the cartridge 100, whether or not filled with a liquid and/or a gas, and/or whether pressurized or not, may not meet the standards so as to be designated as beverage grade.

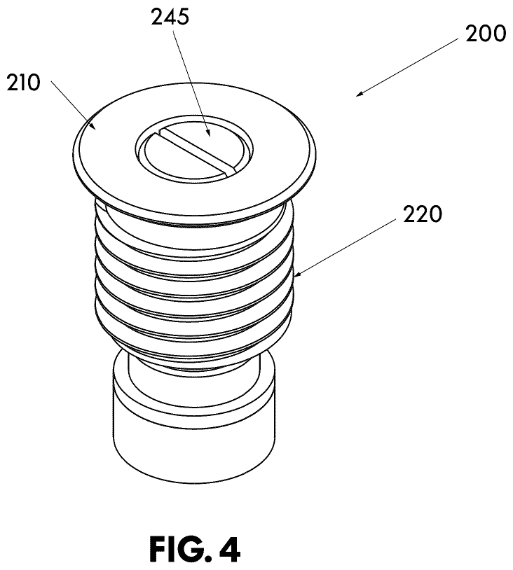

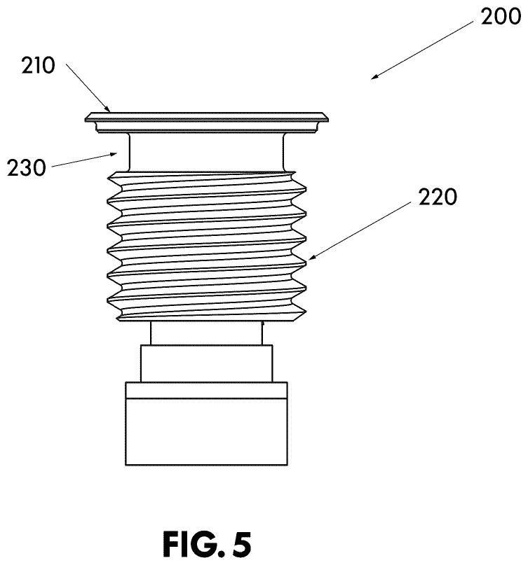

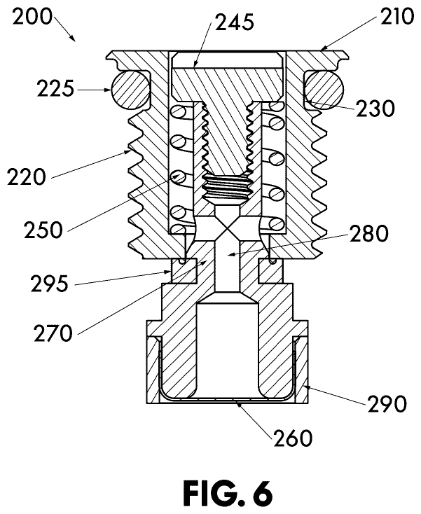

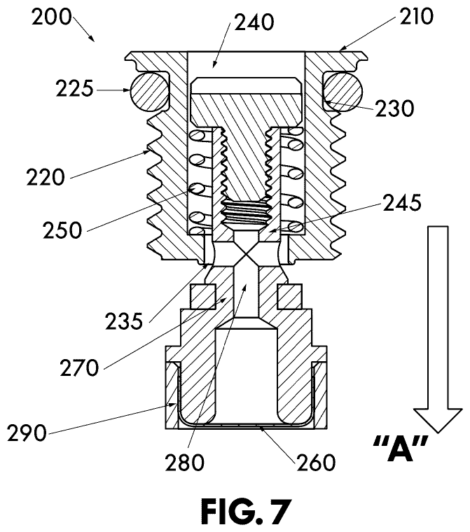

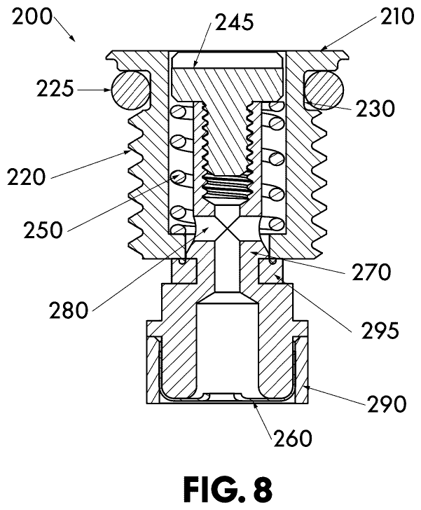

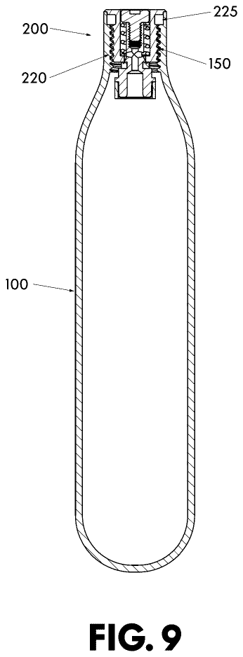

FIG. 4 is a perspective view of a valve 200, in accordance with some embodiments of the invention. FIG. 5 is a front view of the valve 200, in accordance with some embodiments of the invention. FIG. 6 is a cross-sectional view of the valve 200, in accordance with some embodiments of the invention. FIG. 7 is another cross-sectional view of the valve 200, in accordance with some embodiments of the invention. FIG. 8 is another cross-sectional view of the valve 200, in accordance with some embodiments of the invention. FIG. 9 is a cross-sectional view of the valve 200 within the cartridge 100, in accordance with some embodiments of the invention.

As shown in the figures, in some embodiments, the valve 200 may be installed within the cartridge 100. In some embodiments, the valve 200 may be installed within the cartridge neck 120 of the cartridge 100. Although not shown in the figures, in some embodiments, the valve 200 may be installed within a portion of the cartridge 100 other than the cartridge neck 120.

In some embodiments, actuation of the valve 200 may permit the liquid and/or the gas to flow into the cartridge interior 140 of the cartridge 100, so that the cartridge 100 may be filled with and may store the liquid and/or the gas with the cartridge interior 140. In some embodiments, actuation of the valve 200 may permit the liquid and/or the gas to flow into the cartridge interior 140 of the cartridge 100 until the liquid and/or the gas is pressurized within the cartridge interior 140 of the cartridge 100. In some embodiments, actuation of the valve 200 may permit the liquid and/or the gas stored within the cartridge interior 140 of the cartridge 100 to flow out of the cartridge interior 140 and the cartridge 100, to a volume outside of the cartridge 100.

As shown in the figures, in some embodiments of the invention, the valve 200 may include a valve housing 210. In some embodiments, the valve housing 210 may include one or more valve threads 220. In some embodiments, the valve threads 220 may be sized, shaped, located, and/or dimensioned to threadingly engage the cartridge threads 150 of the cartridge neck 120, so that the valve 200 may be disposed within the cartridge neck 120 of the cartridge 100. In some embodiments, the valve threads 220 and/or the cartridge threads 150 may be sized, shaped, located, and/or dimensioned to impede flow of the liquid and/or the gas that is stored within the cartridge interior 140, between the valve 200 and the cartridge 100. In some embodiments, the valve threads 220 and/or the cartridge threads 150 may be sized, shaped, located, and/or dimensioned to impede flow of the liquid and/or the gas that is stored within the cartridge interior 140, between the cartridge neck 120 of the cartridge 100 and the valve housing 210 of the valve 200.

In some embodiments, the valve 200 may include a first sealing component 225. In some embodiments, when the valve threads 220 of the valve 200 threadingly engage the cartridge threads 150 of the cartridge 100, the first sealing component 225 may impede flow of the liquid and/or the gas from the cartridge 100, between the valve 200 and the cartridge 100. In some embodiments, the first sealing component 225 may be a gasket. In some embodiments, the first sealing component 225 may be an O-ring. In some embodiments, the first sealing component 225 may have a circular cross-section. In some embodiments, the first sealing component 225 may have a non-circular cross-section. In some embodiments, the first sealing component 225 may have an arcuate cross-section. In some embodiments, the first sealing component 225 may have an elliptical cross-section. In some embodiments, the first sealing component 225 may be formed from an elastic material. In some embodiments, the first sealing component 225 may be formed from an inelastic material. In some embodiments, the first sealing component 225 may elastically deform when the valve 200 is installed in the cartridge 100. In some embodiments, the first sealing component 225 may plastically deform when the valve 200 is installed in the cartridge 100.

In some embodiments, the first sealing component 225 may be installed in a valve groove 230 in the valve housing 210. In some embodiments, at least a portion of the valve groove 230 may have a circular cross-section. In some embodiments, at least a portion of the valve groove 230 may have a non-circular cross-section. In some embodiments, at least a portion of the valve groove 230 may have an arcuate cross-section. In some embodiments, at least a portion of the valve groove 230 may have an elliptical cross-section. In some embodiments, at least a portion of a cross-section of the valve groove 230 may be the same as at least a portion of a cross-section of the first sealing component 225. In some embodiments, at least a portion of a cross-section of the valve groove 230 may be different from at least a portion of a cross-section of the first sealing component 225.

In some embodiments, the valve 200 may be positionable between a first position to permit flow between the cartridge interior 140 of the cartridge 100 and a volume outside of the cartridge 100, and a second position to impede flow between the cartridge interior 140 of the cartridge 100 and the outside of the cartridge 100.

In some embodiments, the valve 200 may include a first flow path 235 through a valve interior 240 of the valve 200. As discussed, in some embodiments, the valve 200 may be positionable to permit flow both into and out of the cartridge interior 140 of the cartridge 100 through the first flow path 235 of the valve interior 240. Thus, in some embodiments, a liquid and/or a gas may flow from outside of the cartridge 100, through the first flow path 235 of the valve interior 240, and into the cartridge interior 140 of the cartridge 100. In some embodiments, the liquid and/or the gas stored within the cartridge interior 140 of the cartridge 100 may flow from the cartridge interior 140, through the first flow path 235 of the valve interior 240, and outside of the cartridge 100. In some embodiments, one or more components of the valve 200 may be positionable to flow the liquid and/or the gas from outside of the cartridge 100, through the first flow path 235 of the valve interior 240, and into the cartridge interior 140 of the cartridge 100. In some embodiments, one or more components of the valve 200 may be positionable to flow the liquid and/or the gas stored within the cartridge interior 140 of the cartridge 100, from the cartridge interior 140, through the first flow path 235 of the valve interior 240 of the valve 200, and to the outside of the cartridge 100.

In some embodiments, the valve 200 may include a valve stem 245. In some embodiments, the valve stem 245 may be positionable to flow the liquid and/or the gas into and/or out of the cartridge interior 140 of the cartridge 100, through the first flow path 235 of the valve interior 240. In some embodiments, the valve 200 may include a spring 250. In some embodiments, the valve stem 245 and the spring 250 may be disposed within the valve interior 240 of the valve housing 210. In some embodiments, the spring 250 may bias the valve stem 245 to a closed position—that is, so as to impede flow through the first flow path 235 of the valve interior 240. In some embodiments, as shown in the figures, the valve stem 245 may be formed as two pieces. By this arrangement, the spring 250 may be installed within the valve interior 240, encircling a first piece of the valve stem 245. A second piece of the valve stem 245 may be installed within the valve interior 240, such that the spring 250 is retained between the second piece of the valve stem 245 and a surface of the valve interior 240. In some embodiments, as shown in the figures, the first and second pieces of the valve stem 245 may include interior and exterior threads, which threadingly engage with one another, thereby connecting the pieces of the valve stem 245 to one another.

For example, as shown in FIG. 7, in some embodiments of the invention, when valve stem 245 is urged in a direction “A” by an actuator as described, direction “A” being opposite to the bias provided by spring 250, the valve stem 245 may be in an “open” position, to permit flow between the valve stem 245 and the valve housing 210, by opening the first flow path 235 of the valve interior 240. As shown in FIG. 8, in some embodiments of the invention, when the valve stem 245 is not urged in the direction “A,” the spring 250 may act to urge the valve stem 245 (that is, the spring 250 may bias the valve stem 245) to a “closed” position, to impede flow between the valve stem 245 and the valve housing 210, by closing the first flow path 235 of the valve interior 240.

In some embodiments, the valve stem 245 may be moved in the direction “A” when filling the cartridge interior 140 of the cartridge 100 with the liquid, the gas, the pressurized liquid, and/or the pressurized gas—that is, when the liquid and/or the gas is flowed into the cartridge interior 140 of the cartridge 100. In some embodiments, the valve stem 245 may be moved in the direction “A” when releasing the liquid and/or the gas stored in the cartridge interior 140 of the cartridge 100—that is, when the valve 200 is actuated, to flow the liquid and/or gas stored within the cartridge interior 140 of the cartridge 100, to a space or volume outside of the cartridge interior 140.

In some embodiments, the valve 200 may include a valve disk 260. In some embodiments, the valve disk 260 may impede flow through the valve 200 under certain conditions. In some embodiments, the valve disk 260 may permit flow through the valve 200 under certain conditions. In some embodiments, the valve disk 260 may provide flow through at least a portion of a stem interior 270 of the valve stem 245 under certain conditions. In some embodiments, the valve disk 260 may provide flow through a second flow path 280 of the stem interior 270 under certain conditions.

In some embodiments, the valve disk 260 may be configured to rupture (e.g., break) at a predetermined pressure that is less than a pressure at which any other portion of the cartridge 100 and/or the valve 200 may yield and/or rupture, thereby preventing yielding and/or rupturing of the cartridge 100 and/or the valve 200, when the cartridge 100 including the valve 200 having the valve disk 260 is in the cartridge neck 120 of the cartridge 100. Thus, for example, in some embodiments, when the cartridge 100 has a yield pressure of at least 4,900 PSI, and/or a burst pressure of at least 6,000 PSI, the valve disk 260 may be sized, shaped, positioned, dimensioned, and/or made from an appropriate material, such that the valve disk 260 may rupture at a pressure of less than each of the yield and burst pressure. In some embodiments, when the cartridge 100 is over-pressurized, the valve disk 260 may rupture so that the cartridge 100 and/or the valve 200 does not yield and/or burst. FIG. 8 shows a cross-sectional view of the valve disk 260 after being exposed to a predetermine pressure that ruptures the valve disk 260.

In some embodiments, the valve disk 260 may rupture at more than 6,000 PSI. In some embodiments, the valve disk 260 may rupture at 6,000 PSI. In some embodiments, the valve disk 260 may rupture at 5,900 PSI. In some embodiments, the valve disk 260 may rupture at 5,800 PSI. In some embodiments, the valve disk 260 may rupture at 5,700 PSI. In some embodiments, the valve disk 260 may rupture at 5,600 PSI. In some embodiments, the valve disk 260 may rupture at 5,500 PSI. In some embodiments, the valve disk 260 may rupture at 5,400 PSI. In some embodiments, the valve disk 260 may rupture at 5,300 PSI. In some embodiments, the valve disk 260 may rupture at 5,200 PSI. In some embodiments, the valve disk 260 may rupture at 5,100 PSI. In some embodiments, the valve disk 260 may rupture at 5,000 PSI. In some embodiments, the valve disk 260 may rupture at 4,900 PSI. In some embodiments, the valve disk 260 may rupture at 4,800 PSI. In some embodiments, the valve disk 260 may rupture at 4,700 PSI. In some embodiments, the valve disk 260 may rupture at 4,600 PSI. In some embodiments, the valve disk 260 may rupture at 4,500 PSI. In some embodiments, the valve disk 260 may rupture at 4,400 PSI. In some embodiments, the valve disk 260 may rupture at 4,300 PSI. In some embodiments, the valve disk 260 may rupture at 4,200 PSI. In some embodiments, the valve disk 260 may rupture at 4,100 PSI. In some embodiments, the valve disk 260 may rupture at 4,000 PSI. In some embodiments, the valve disk 260 may rupture at 3,900 PSI. In some embodiments, the valve disk 260 may rupture at 3,800 PSI. In some embodiments, the valve disk 260 may rupture at 3,700 PSI. In some embodiments, the valve disk 260 may rupture at 3,600 PSI. In some embodiments, the valve disk 260 may rupture at 3,500 PSI. In some embodiments, the valve disk 260 may rupture at 3,400 PSI. In some embodiments, the valve disk 260 may rupture at 3,300 PSI. In some embodiments, the valve disk 260 may rupture at 3,200 PSI. In some embodiments, the valve disk 260 may rupture at 3,100 PSI. In some embodiments, the valve disk 260 may rupture at 3,000 PSI. In some embodiments, the valve disk 260 may rupture at less than 3,000 PSI.

In some embodiments, when the valve disk 260 is not ruptured, the valve disk 260 may impede flow through the second flow path 280 of the stem interior 270 into and/or out of the cartridge interior 140 of the cartridge 100, such as by blocking the second flow path 280. In some embodiments, when the valve disk 260 is ruptured, the valve disk 260 may permit flow through the second flow path 280 of the stem interior 270 into and/or out of the cartridge interior 140 of the cartridge 100.

In some embodiments, the valve disk 260 may be attached to a face of the valve stem 245. Although not shown, in some embodiments, the valve disk 260 may be attached to something other than a face of the valve stem 245. In some embodiments, the valve disk 260 may be attached to the face of the valve stem 245 by an annular component 290. In some embodiments, the annular component 290 may be removably attached to the valve stem 245. In some embodiments, the annular component 290 may be irremovably attached to the valve stem 245. In some embodiments, the valve disk 260 may be attached to the face of the valve stem 245 by something other than the annular component 290.

In some embodiments, the valve 200 may include a valve seat 295. In some embodiments, the valve seat 295 may come into and out of contact with the valve housing 210, to thereby permit and impede flow between the valve housing 210 and the valve stem 245, through the first flow path 235 of the valve interior 240 (that is, “open” and “close” the first flow path 235). In some embodiments, the valve seat 295 may be a separate component from the valve stem 245. In some embodiments, the valve seat 295 may be a portion of the valve stem 245. In some embodiments, the valve seat 295 may be omitted, and a portion of the valve stem 245 may be movable into and out of contact with the valve housing 210, to thereby permit and impede flow between the valve housing 210 and the valve stem 245, through the first flow path 235 of the valve interior 240.

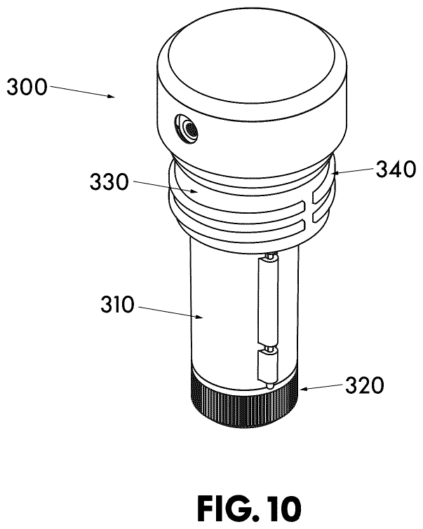

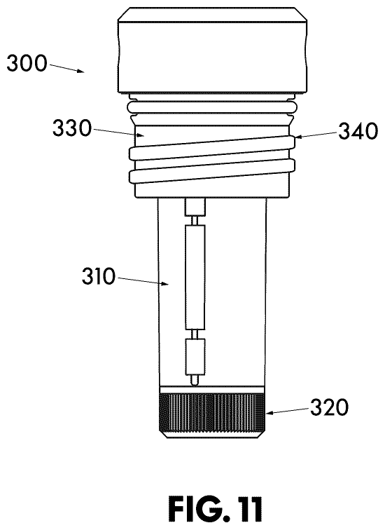

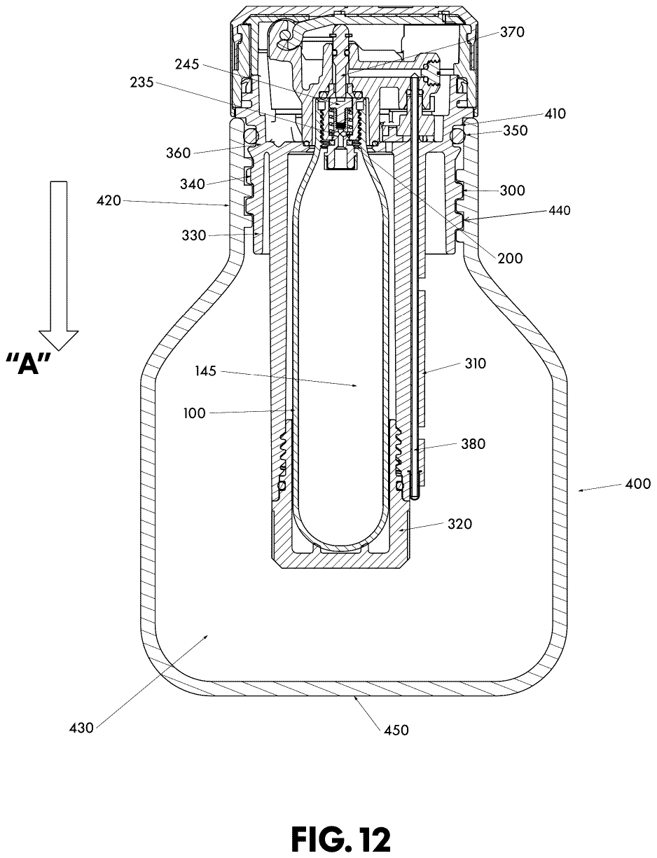

FIG. 10 is a perspective view of a pressurizer 300, in accordance with some embodiments of the invention. FIG. 11 is a front view of the pressurizer 300, in accordance with some embodiments of the invention. FIG. 12 is a cross-sectional view of the pressurizer 300 including the cartridge 100 and the valve 200, installed in a container 400, in accordance with some embodiments of the invention.

As shown in the figures, the pressurizer 300 may be installed within an opening of the container 400, so that at least a portion of the pressurizer 300 may be within a container interior 430 of the container 400. In some embodiments, the pressurizer 300 may be installed through a container opening 410 in a top end 420 of the container 400. In some embodiments, the container 400 may be filled with the fluid (e.g., the liquid) that is stored with the container interior 430 through the container opening 410 in the top end 420 of the container 400.

As discussed, in some embodiments, the container 400 may store the liquid within the container interior 430, such as a drinkable liquid. Also as discussed, in some embodiments, the pressurizer 300 may actuate the valve 200 installed in the cartridge 100, such as by moving the valve stem 245 of the valve 200 in the direction “A,” thereby flowing the liquid, the gas, the pressurized liquid, and/or the pressurized gas stored within the cartridge interior 140 of the cartridge 100, from the cartridge 100, through the valve 200, into the liquid stored in the container interior 430 of the container 400. As further discussed, in some embodiments, the pressurizer 300 may actuate the valve 200 installed in the cartridge 100, flowing the liquid and/or the gas stored in the cartridge 100, from the cartridge 100, through the valve 200, into the liquid stored in the container interior 430 of the container 400, to pressurize the liquid stored in the container interior 430 of the container 400.

In some embodiments, the container 400 may be a bottle. In some embodiments, the container 400 may be a canteen. In some embodiments, the container 400 may be a thermos. In some embodiments, the container 400 may be insulated. In some embodiments, the container 400 may be uninsulated. In some embodiments, the container 400 may be made from a plastic material. In some embodiments, the container 400 may be made from a glass material. In some embodiments, the container 400 may be made from a metal material. In some embodiments, the metal material may be one or more of aluminum, iron, steel, stainless steel, titanium, and/or combinations of these and/or other metals. In some embodiments, the container 400 may be a combination of plastic, metal, and/or glass, with or without another material and/or other materials.

As shown in the figures, the pressurizer 300 may include a first pressurizer body 310. In some embodiments, the cartridge 100 may be installed within an opening of the first pressurizer body 310. In some embodiments, when the pressurizer 300 is installed in the container interior 430 of the container 400, the first pressurizer body 310 may be installed within the container interior 430 of the container 400. In some embodiments, the valve 200 may be installed in the cartridge 100, the cartridge 100 may include the liquid, the gas, the pressurized liquid, and/or the pressurized gas stored within the cartridge interior 140, and the cartridge 100 may be installed within the first pressurizer body 310 of the pressurizer 300. In some embodiments, the pressurizer 300 may include a cap 320 closing an end of the first pressurizer body 310. In some embodiments, the cap 320 may be removable for installation of the cartridge 100 within the first pressurizer body 310 of the pressurizer 300. In some embodiments, each of the cap 320 and the first pressurizer body 310 may include at least one thread, and the at least one thread of each of the cap 320 and the first pressurizer body 310 may threadingly engage with one another, thereby to secure the cap 320 to the first pressurizer body 310.

In some embodiments, the pressurizer 300 may include a second pressurizer body 330. In some embodiments, the second pressurizer body 330 may connect the pressurizer 300 with the container 400.

In some embodiments, the second pressurizer body 330 of the pressurizer 300 may include one or more pressurizer threads 340. In some embodiments, the pressurizer threads 340 may be sized, shaped, located, and/or dimensioned to threadingly engage one or more container threads 440 of the container 400. In some embodiments, the pressurizer threads 340 of the pressurizer 300 may threadingly engage the container threads 440 of the container 400, to impede flow of the liquid and/or the gas within the container 400, between the pressurizer 300 and the container 400.

In some embodiments, the pressurizer 300 may include a second sealing component 350. In some embodiments, when the pressurizer threads 340 threadingly engage the container threads 440 of the container 400, the second sealing component 350 may impede flow of the liquid and/or the gas stored within the container 400, between the pressurizer 300 and the container 400.

In some embodiments, the second sealing component 350 may be a gasket. In some embodiments, the second sealing component 350 may be an O-ring. In some embodiments, the second sealing component 350 may have a circular cross-section. In some embodiments, the second sealing component 350 may have a non-circular cross-section. In some embodiments, the second sealing component 350 may have an actuate cross-section. In some embodiments, the second sealing component 350 may have an elliptical cross-section. In some embodiments, the second sealing component 350 may be formed from an elastic material. In some embodiments, the second sealing component 350 may be formed from an inelastic material. In some embodiments, the second sealing component 350 may elastically deform when the pressurizer 300 is installed in the container 400. In some embodiments, the second sealing component 350 may plastically deform when the pressurizer 300 is installed in the container 400.

In some embodiments, the second sealing component 350 may be installed in a pressurizer groove 360 in the second pressurizer body 330. In some embodiments, at least a portion of the pressurizer groove 360 may have a circular cross-section. In some embodiments, at least a portion of the pressurizer groove 360 may have a non-circular cross-section. In some embodiments, at least a portion of the pressurizer groove 360 may have an arcuate cross-section. In some embodiments, at least a portion of the pressurizer groove 360 may have an elliptical cross-section. In some embodiments, at least a portion of a cross-section of the pressurizer groove 360 may be the same as at least a portion of a cross-section of the second sealing component 350. In some embodiments, at least a portion of a cross-section of the pressurizer groove 360 may be different from at least a portion of a cross-section of the second sealing component 350.

In some embodiments, the pressurizer 300 may include an actuator 370. In some embodiments, application of a force beyond a predetermined threshold (that is, actuation) of the actuator 370 may move the valve stem 245 of the valve in the direction “A,” thereby moving the valve stem 245 to the “open” position and opening the valve 200. In some embodiments, the liquid, the gas, the pressurized liquid, and/or the pressurized gas stored within the cartridge interior 140 of the cartridge 100 may flow from the cartridge interior 140 of the cartridge 100, though the first flow path 235 of the valve interior 240, into the liquid stored in the container interior 430 of the container 400. In some embodiments, a sufficient amount of the pressurized liquid and/or gas in the cartridge interior 140 of the cartridge 100 flows into the liquid stored in the container interior 430 of the container 400, so that the liquid stored in the container interior 430 is pressurized.

In some embodiments, the pressurizer 300 includes a third flow path 380. In some embodiments, the first pressurizer body 310 may include the third flow path 380. As shown in the figures, the third flow path 380 may have an exit at a lower end of the first pressurizer body 310. In some embodiments, when the valve stem 245 is actuated by the actuator 370 (that is, when the valve 200 is opened by moving the valve stem 245 in the direction “A”), the liquid, the gas, the pressurized liquid, and/or the pressurized gas stored within the cartridge interior 140 of the cartridge 100, flows from the cartridge interior 140, through the first flow path 235 of the valve interior 240, though the third flow path 380 of the pressurizer 300, and into the container interior 430 of the container 400. As discussed, in some embodiments, the container interior 430 of the container stores a fluid, such as a liquid, and such as a drinkable liquid. In some embodiments, the exit of the third flow path 380 of the pressurizer 300 is lower than an uppermost surface of the liquid that is stored in the container interior 430 of the container 400. Thus, in some embodiments, a pressurized liquid and/or pressurized gas in the cartridge interior 140 of the cartridge 100 flows into the liquid stored in the container interior 430 of the container 400, thereby pressurizing the liquid stored in the container interior 430 of the container 400.

In some embodiments, a user of the pressurizer 300 may install the valve 200 in the cartridge 100. In some embodiments, the valve 200 may be installed in the cartridge 100 prior to the user acquiring the pressurizer 300 and/or the cartridge 100. In some embodiments, the user of the pressurizer 300 may install the cartridge 100 that includes the valve 200, and which includes the liquid, gas, pressurized liquid, and/or pressurized gas within the cartridge interior 140 of the cartridge 100, into the pressurizer 300. In some embodiments, the cartridge 100 including the valve 200 may be installed in the pressurizer 300 prior to the user acquiring the pressurizer 300. In some embodiments, the user may fill the container interior 430 of the container 400 with a liquid, such as a drinkable liquid. In some embodiments, the user may install the pressurizer 300 in the container 400. In some embodiments, the user may actuate the actuator 370, thereby flowing the liquid, the gas, the pressurized liquid, and/or the pressurized gas from the cartridge 100 into the liquid stores in the container 400. Thus, in some embodiments, when the cartridge 100 includes a pressurized liquid and/or gaseous carbon dioxide in the cartridge interior 140, the user may carbonate the liquid stored in the container interior 430 of the container 400.

In some embodiments, the user may remove the pressurizer 300 from the container 400, thereby to access the liquid stored in the container interior 430 of the container 400, such as, for example, to drink the liquid. In some embodiments, the user may remove the pressurizer 300 from the container 400, thereby to access the liquid stored in the container interior 430 of the container 400 that is mixed with the liquid and/or the gas from the cartridge 100 (that is, to access a mixture of the liquids and/or the gases).

As shown in the figures, in some embodiments, when the pressurizer 300 is installed in the container 400, the valve 200 in the cartridge 100, which is installed in the pressurizer 300, is proximate or adjacent to the top end 420 of the container 400, and distal or away from a bottom end 450 of the container 400 which is opposite the top end 420.

As shown in the figures, in some embodiments, when the pressurizer 300 is installed in the container 400, and the valve 200 is installed in the cartridge 100, the first flow path 235 may extend in a first direction, the second flow path 280 may extend in a second direction, and the third flow path 380 may extend in a third direction. In some embodiments, any of the first, second, and third directions may be the same as any other of the first, second, and third directions. In some embodiments, any of the first, second, and third directions may be the same as any other of the first, second, and third directions. In some embodiments, the first and second directions may be the same as each other, and may be different than the third direction. In some embodiments, at least a portion of the third direction may be opposite to the first direction and/or the second direction.

In some embodiments, the invention may provide one or more methods, in which any or all of, and/or one or more other components, are obtained, including but not limited to the container 400, the pressurizer 300, the valve 200, and/or the cartridge 100, and/or any of the elements of the container 400, the pressurizer 300, the valve 200, and/or the cartridge 100.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms, without altering their respective meanings as defined herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1-20. (canceled)

21. A method, comprising:
installing a cap onto a container,
wherein the container comprises:
a chamber containing a pressurized fluid, and
a threaded opening having threads,
wherein the cap comprises:
a threaded interface adapted to engage threads of the container,
a pressure venting valve disposed within the cap, wherein the pressure venting valve comprises:
a valve housing,
a movable element that is movable within the valve housing to open and close a valve intake to the chamber, and
an outer grip retained to the cap such that the outer grip rotates freely relative to the threaded interface,
wherein the installing the cap onto the container seals the chamber;
twisting the outer grip in a first rotational direction to actuate the pressure venting valve, wherein the actuation moves the movable element in a first direction to open the pressure venting valve; and
maintaining the twist of the outer grip so as to permit the pressurized fluid in the chamber to exit through the open pressure venting valve and out of the cap toward atmosphere.

22. The method of claim 21, wherein the cap further comprises a main seal disposed between the cap and the container, and the main seal comprises an O-ring.

23. The method of claim 21,
wherein the pressure venting valve further comprises a spring biasing the movable element toward a closed position, and
wherein the method further comprises releasing the outer grip so as to allow the spring to move the movable element so as to close the valve intake to the chamber, thereby stopping further exit of the pressurized fluid.

24. The method of claim 21, wherein the first rotational direction is opposite a tightening direction of the threaded interface.

25. The method of claim 21, further comprising: rotating, by the user, the outer grip by approximately 30 degrees to actuate the pressure venting valve.

26. The method of claim 21, wherein the cap further comprises vent grooves or openings adapted to direct fluid exiting the pressure venting valve toward atmosphere.

27. The method of claim 21, wherein the cap further comprises a valve intake chamber in fluid communication with the chamber of the container, and wherein twisting, by the user, moves the valve stem away from the valve intake chamber to permit exit of the pressurized fluid.

28. The method of claim 21, wherein the cap further comprises a pressure-relief hole positioned to allow pressure to escape when the cap is being removed from the container while the pressure venting valve is closed.

29. The method of claim 21, wherein the outer grip comprises outer grip retention stops adapted to limit rotation relative to the cap body, and the retention feature constrains the outer grip axially while permitting free rotation relative to the threaded interface.

30. The method of claim 21, wherein the cap further comprises a t-pin attached to the valve stem, and wherein twisting, by the user, causes the valve ramp of the outer grip to contact and translate the t-pin to move the valve stem in the first direction.

31. The method of claim 21,
wherein the outer grip further comprises a valve ramp, and
wherein twisting the outer grip in the first rotational direction causes the valve ramp to move the movable element in the first direction to open the pressure venting valve.

32. The method of claim 31, further comprising:
twisting the outer grip in a second rotational direction that is opposite the first rotational direction, thereby causing the valve ramp to move the movable element in a second direction that is opposite the first direction so as to close the pressure venting valve.

33. The method of claim 21, wherein the movable element comprises a valve stem.

34. A method, comprising:
installing a cap into a vessel,
wherein the vessel comprises:
a chamber containing a fluid, and
an opening into the chamber,
wherein the cap comprises:
a core body adapted to be positioned within the opening so as to seal the chamber,
wherein the core body defines an inlet passage;
installing a single-use capsule into an adapter,
wherein the single-use capsule comprises:
a chamber containing a pressurized material, and
a pierceable membrane sealing the chamber,
wherein the adapter comprises:
a sealing feature adapted to form a seal with the single-use capsule,
a piercing feature positioned to rupture the pierceable membrane,
an outer body, and
a two-way valve adapted to control flow of material into and out of the adapter, and
wherein the installing the single-use capsule into the adapter causes the piercing feature to rupture the pierceable membrane, resulting in the pressurized material entering the two-way valve;
installing the adapter into the cap,
wherein the installing the adapter into the cap causes an outlet of the two-way valve to be in fluid communication with the inlet passage of the core body;
actuating the two-way valve to discharge at least a portion of the pressurized material from the capsule through the adapter and the inlet passage into the chamber of the vessel,
wherein the discharge of the at least a portion of the pressurized material into the chamber of the vessel results in pressurizing the fluid in the chamber by mixing the discharged pressurized gas from the capsule with the fluid in the chamber.

35. The method of claim 34, wherein the sealing feature comprises an O-ring positioned between the outer body of the adapter and the capsule to impede leakage of the pressurized material during engagement of the single-use capsule with the adapter.

36. The method of claim 34, wherein the two-way valve is adapted to permit both intake of the pressurized material into the adapter and discharge of the pressurized material from the adapter in response to actuation of the valve.

37. The method of claim 34, wherein the cap further comprises a user-actuated release valve adapted to regulate discharge of the pressurized material from the adapter into the chamber of the vessel through a nozzle of the core body.

38. The method of claim 34, wherein the adapter is configured to interface with the core body in a manner that provides the same outlet connection and sealing interface as a reusable capsule valve assembly.

39. The method of claim 34, wherein the piercing feature comprises a replaceable piercing tip retained within the outer body.

40. The method of claim 34,
wherein the single-use capsule comprises a threaded interface,
wherein the adapter comprises a threaded interface that is sized to engage the threaded interface of the single-use capsule, and
wherein the adapter and the single-use capsule are adapted such that threaded engagement of the threaded interface of the single-use capsule with the threaded interface of the adapter brings the piercing feature into contact with the pierceable membrane so as to rupture the pierceable membrane.

41. The method of claim 40, wherein the outer body comprises grooves onto which a wrench or tightening device is affixed to increase torque during threaded engagement of the single-use capsule with the adapter.

42. The method of claim 34, wherein the adapter further comprises a check valve downstream of the two-way valve configured to impede backflow from the core body into the adapter.

43. The method of claim 34,
wherein the pressurized material discharged from the capsule comprises carbon dioxide that is one of liquid carbon dioxide or gaseous carbon dioxide, and
wherein the pressurizing the fluid in the chamber comprises mixing the carbon dioxide with the fluid to increase a pressure within the chamber of the vessel selected from a thermos, a bottle, or a canteen.
